(19) United States
(12) Patent Application Publication
(10) Pub. No.: US 2004/0267545 A1
(43) Pub. Date: Dec. 30, 2004

(54) Mobile transponder reader

(76) Inventors: Harald Buchmann, Bindlach (DE); Gerald Dittrich, Thurna (DE)

Correspondence Address: SCULLY SCOTT MURPHY & PRESSER, PC, 400 GARDEN CITY PLAZA, GARDEN CITY, NY, 11530

(21) Appl. No.: 10/489,627

(22) PCT Filed: Sep. 13, 2002
(86) PCT No.: PCT/EP02/10308

(30) Foreign Application Priority Data
Sep. 14, 2001 (DE) 101 45 498.8

(51) Int. Cl. G06F 17/60

(52) U.S. Cl. 705/1

(57) ABSTRACT

The invention relates to a mobile reader (1) for reading out information from a transponder (10). Said mobile reader comprises a first transmitter/receiver device (2) for emitting a read-out signal to a transponder (10) and for receiving a response signal emitted by the transformer (10) in response to the read-out signal, wherein said response signal comprises identification information for identifying the transponder (10). The first transmitter/receiver device (2) functions with wireless communication on the basis of electromagnetic waves in a first frequency range. The mobile reader (1) further comprises a second transmitter/receiver device (3) for the wireless communication with a base station on the basis of electromagnetic waves in a second frequency range. The second transmitter/receiver device (3) transmits the identification information received by the first transmitter/receiver device in the response signal to the base station.

The present invention comprises a mobile reader for reading out information from a transponder.

Transponders are passive components, which are used for the identification of objects and/or goods during processing and/or transport. In each case, a transponder is attached either to the object itself or to a container containing the object. Information, which can be read out by appropriate transponder readers, is stored or contained in the transponder. In this context, one transponder is generally firmly attached to each container and/or each object. For example, in the manufacture of silicon wafers, which are transported in synthetic material containers, the relevant transponder can be welded onto the relevant synthetic material container or attached in a corresponding holder. The transponder readers are arranged in a stationary manner in transport and/or processing stations along the transport and/or processing chain for the objects. These stationary transponder readers are available as read-only or read-write devices. The transponders are also available as read-only or as read-write transponders. With the read-only version, the transponders are generally provided by the manufacturer with identification information, e.g., a number, which is guaranteed to be unique. During use, the transponders can be read by stationary read-only devices in the relevant processing and/or transport stations.

With the read-write version, the transponders are not only read out by stationary read-write devices in the transport and/or processing stations; they can also be provided with appropriate new information, such as information relating to processing status etc. The transponder readers arranged in a stationary manner in the transport and/or processing stations are generally connected, by means of a hard-wired network, to a central control computer. Updated transport and/or processing information relating to each transponder and/or to the object allocated to each transponder is communicated to the central computer. This information can then be used either to control the processing and transport of the objects carrying the transponders or for display and monitoring.

The areas of application for transponders and the corresponding transponder readers are very numerous. For example, transponders can be used for marking objects such as pallets, hurdles, hoppers, crates, trays or even tools and vehicles. In combination with the known stationary transponder readers, transport and processing stages relating to the objects marked with the transponders can be monitored and optionally controlled in a simple and efficient manner.

The disadvantage of the system explained above for controlling and monitoring the transport and/or processing of objects by means of transponders attached to the objects and stationary transponder readers is that the information contained in the individual transponders is not accessible while the objects or the containers containing the objects are conveyed from one processing and/or transport station to the next. In particular, this is the case, if the objects carrying the transponders are placed in intermediate storage between processing stages. The arrangement of a stationary transponder reader device in every storage place would be much too resource-intensive and expensive. Accordingly, the known systems do not allow identification of the objects carrying the transponders at all times; neither do they allow lost objects to be sought and found. If objects carrying transponders are disposed in the wrong place, and/or if the information, regarding where the object has been stored is lost, it is no longer possible to find and/or to identify the object.

The object of the present invention is therefore to provide a device, which allows objects carrying transponders to be sought, tracked and checked at any time.

This object is achieved with a mobile reader for reading out information from transponders according to claim 1. The mobile reader according to the invention comprises a first transmitter/receiver device for transmitting a read-out signal to a transponder and for receiving a response signal emitted by a transponder in response to the read-out signal with identification information for identifying the transponder, wherein the first transmitter/receiver device operates in a wireless manner and on the basis of electromagnetic waves within a first frequency range. Furthermore, the mobile reader according to the invention comprises a second transmitter/receiver device for wireless communication with a base station on the basis of electromagnetic waves within a second frequency range, wherein the second transmitter/receiver device communicates the identification information, received in the response signal from the first transmitter/receiver device, to the base station.

The mobile reader according to the invention therefore allows objects carrying transponders to be tracked and monitored at any time. The first transmitter/receiver device, in this context, reads out the identification information contained in the transponder and communicates the identification information via the second transmitter/receiver device to a base station. The base station is advantageously connected to a network, which contains a central computer for the storage and management of information relating to the processing of the objects carrying the transponders. The stationary transponder readers in the transport and/or processing stations are advantageously also connected to the network. As a result, a user of the mobile reader can track an object carrying a transponder at any time and in any place, identify it and optionally also determine the processing and/or transport status of the object via the central computer.

The mobile reader advantageously comprises a micro-controller for converting identification information contained in the response signal into a signal format suitable for transmission to a base station by the second transmitter/receiver device.

Furthermore, in response to transmitted identification information, the second transmitter/receiver device advantageously receives processing information transmitted from the base station and referring to the processing of the transponder. In this context, the mobile reader advantageously provides a display device for displaying the processing information received from the base station.

The communication between the first transmitter/receiver device and the transponder advantageously takes place on the basis of frequency-modulated signals. Alternatively, it may be advantageous, if the communication between the first transmitter/receiver device and the transponder takes place on the basis of amplitude-modulated signals.

The first frequency range is advantageously disposed within the range of some hundred kHz. Alternatively, it may be advantageous, if the first frequency range is disposed within the range of some MHz.

The second transmitter/receiver device advantageously communicates with the base station on the basis of DECT standards. Alternatively, this communication can also take place on the basis of the Wireless-LAN standard (2.4 GHz). Furthermore, the second frequency range is advantageously disposed within the range of some GHz.

Moreover, the present invention relates to a network for monitoring objects carrying transponders, with several base stations for communicating with mobile readers according to the present invention and a central computer for storage and management of information relating to the processing of the objects carrying the transponders, wherein, on receiving identification information from a base station, the central computer communicates processing information referring to the relevant transponder back to the base station.

The central computer is advantageously connected to a processing station for processing the objects carrying the transponders, wherein each processing station comprises a processing device for registering the relevant processing status of an object carrying a transponder in the processing station and for communicating the relevant processing information to the central computer.

Furthermore, a processing computer is advantageously provided for controlling the communication between the central computer and the base station.

The mobile reader according to the invention allows objects carrying transponders to be sought, tracked and identified simply, efficiently and independently of transponder readers arranged in a stationary manner. With the mobile reader according to the invention, a user can read the identification information contained in a transponder for the identification of the object carrying the transponder at any time and in any location, and communicate this in a wireless manner to a base station. In this context, the reader according to the invention is not allocated to a fixed base station; the mobile reader is allocated in a dynamic manner to the base station, which is most easily contacted at the moment and communicates with this base station. The use of electromagnetic waves for the transmission of information between the mobile reader and the base station is advantageous, because no direct line of sight is necessary, as is required with other transmission options. This is particularly advantageous in complex production or storage facilities.

The display device in the mobile reader is particularly advantageous, if processing information relating to the object carrying the transponder is communicated from the base station in response to transmitted identification information. This processing information can be displayed on the display device, so that the user is immediately informed of the processing status of the object carrying the transponder and/or the materials to be processed which are contained in the object. In this context, the processing information communicated via the base station may contain information regarding already completed stages of processing and/or future processing stages.

The use of the DECT standard and/or the wireless-LAN standard as a basis for the communication between the mobile reader and the base station provides the advantage of a relatively inexpensive and yet simple and reliably-functioning technology. The typical transmission rates and transmission ranges of transmission systems operating on the basis of this standard are adequate for the areas of application of the present invention, and the invention represents an advantageous use of this technology.

In this context, within the network according to the present invention, the information flow between the base stations and the mobile readers can be realised and adapted in a simple manner on the basis of a customer-specific central computer, without the need to define different communication protocols between the mobile readers and the base stations for different customer-specific central-computer systems.

The present invention will be described in greater detail on the basis of an exemplary embodiment with reference to the attached drawings. The drawings are as follows:

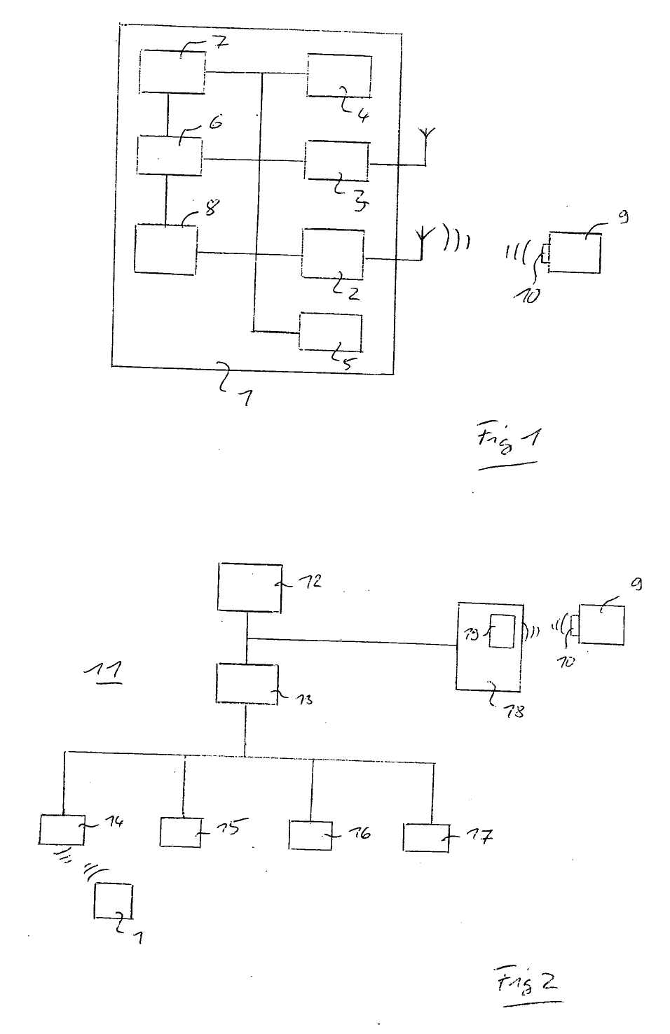

FIG. 1 shows a schematic block circuit diagram of a mobile reader according to the invention and of an object carrying a transponder

FIG. 2 shows a block circuit diagram of a network according to the invention.

FIG. 1 shows a schematic block circuit diagram of a mobile reader 1 according to the present invention and an object 9 carrying a transponder 10. The mobile reader 1 is used for reading out information, such as identification information, from the transponder 10 and, for this purpose, comprises a first transmitter/receiver device 2 for transmitting a read-out signal to the transponder 10 and for receiving a response signal emitted by the transponder 10 in response to the read-out signal. The response signal from the transponder 10 may, for example, contain identification information, which unambiguously identifies the transponder 10. The first transmission/receiver device 2 communicates with the transponder 10 in a wireless manner and on the basis of electromagnetic waves within a first frequency range. Depending on the design of the transponder 10, the communication between the first transmitter/receiver device 2 and the transponder 10 may take place on the basis of amplitude-modulated or frequency-modulated signals. The use of frequency-modulated signals provides the disadvantage that the transponder requires a condenser for storage and delay of the energy communicated with the read-out signal from the first transmitter/receiver device. This increases the cost of the transponder 10. However, the advantage is the greater range, for example, up to 5 m. The use of amplitude-modulated signals allows a simpler and lighter-weight structure of the transponder 10. A small range, for example, a maximum of 2 m, results from auto-interference because the transmitter/receiver device transmits read-out signals continuously, at the same time as the transponder 10 emits a response signal.

Furthermore, the communication between the first transmitter/receiver device 2 and the transponder 10 can take place either in a low-frequency range of approximately 134 kHz or in a high-frequency range of approximately 13 MHz. Although FIG. 1 shows only a single, first transmitter/receiver device 2 for the mobile reader 1, for communicating with the transponder 10, the mobile reader 1 may also be fitted with several transmitter/receiver devices 2 for communication with several transponders of different design.

The mobile reader 1 also comprises a second transmitter/receiver device 3 for wireless communication with one or more base stations 14, 15, 16, 17 (as shown in FIG. 2) on the basis of electromagnetic waves within a second frequency range. The identification information received by the first transmitter/receiver device 2 in the response signal from the transponder 10 is communicated by the second transmitter/receiver device 3 to an accordingly allocated base station 14, 15, 16, 17. In order to extract the identification information contained in the response signal and convert the identification information into a signal format suitable for transmission by the second transmitter/receiver device to a base station, a micro-controller 6 is provided in the mobile reader 1, which also controls the other functions of the reader 1.

The mobile reader 1 also comprises a display device 4, such as an LCD display for the display of the identification information or other information received by the second transmitter/receiver device 3 from a base station 14, 15, 16, 17, and an input device 5, such as a keyboard, by means of which an operator can select, for example, operating conditions of the mobile reader 1, such as transmission of a read-out signal by the first transmitter/receiver device to a transponder 10 or similar.

Furthermore, the mobile reader 1 comprises a memory 7 connected to the micro-controller 6 and the other components, for storing information and/or control programs. Moreover, a power pack or battery 8 is provided, which supplies power to the micro-controller 6 and the other components of the mobile reader 1. The mobile reader 1 is advantageously fitted with a lightweight housing, for example, made from synthetic material, in which the components described above are accommodated. The components described are also advantageously of as light a weight as possible and designed with a very low power consumption. The size and weight of the mobile reader 1 according to the present invention is advantageously such that an operator can carry the mobile reader 1 easily in one hand and can operate it with one hand.

FIG. 2 shows a network 11 according to the invention for monitoring objects 9 carrying transponders 10, for example, in a factory building, a warehouse etc. or any combinations thereof. The network 11 according to the invention may be used, for example, for monitoring and controlling containers containing several silicon wafer disks as the objects 9, which are being processed and/or manufactured within the factory building. A transponder 10, which unambiguously identifies each container, is attached to each of the containers. The relevant processing and transport stages are controlled and managed by a central computer 12. For example, a processing device 19 for registering the relevant processing status of the object 9 is provided in every processing station 18 for processing the objects 9 carrying the transponders 10, for example, silicon wafer disks. The processing device 19 is, for example, a transponder read-write device, which, when the object 9 carrying the transponder 10 arrives in the processing station 18, reads out the identification information in a known manner from the transponder 10 and communicates this information via the network 11 to the central computer 12, together with information relating to the processing stages to be implemented in the processing station 18. The processing stages already completed and the future processing stages for this object 19 are stored in the central computer 12. When the identification information from the processing device 19 is received, the central computer 12 checks whether the processing stage to be implemented by the processing station 18 is the next processing stage on the list and issues correspondingly positive or negative instructions to the processing station 18. If the response from the central computer 12 is positive, then the processing of the object 9 will be implemented. If not, an alarm or similar will be triggered. The network 11 therefore comprises several processing stations 18 of this kind, although these are not illustrated here. The objects 9 carrying the transponders 10 generally approach these processing stations successively in an automated manner.

If an object 9 carrying a transponder 10 arrives at the wrong processing station or if the objects 9 are to be placed into intermediate storage between processing stages, an operator can use the mobile reader 1 according to the invention to read out the identification information from the relevant transponder 10 of the object 9 in a simple manner and communicate this information to the central computer 12, which in turn provides information regarding the processing stages already completed and the future processing stages. This is achieved with a number of base stations 14, 15, 16, 17, which are connected via an operational-information computer 13 to the central computer 12. In this context, the operational-information computer 13 need not necessarily be provided, the allocated functions being taken over by the central computer 12 and/or the base stations. The mobile reader 1 communicates the identification information read out from a transponder 10 via the second transmitter/receiver device 3 to the accordingly allocated base station 14, 15, 16 or 17, which is generally the nearest base station; identification information is then communicated by means of the said base station to the operational-information computer 13. In one advantageous exemplary embodiment, the base stations 14, 15, 16, 17 communicate with the mobile reader(s) 1 on the basis of the DECT (Digital European Cordless Telephone Standard) or the Wireless-LAN Standard. In this context, the frequency range of this communication is disposed at approximately 1.9 MHz (and/or 2.4 GHz), wherein the data transmission takes place in time-multiplex on 10 channels. The range is up to 50 m inside the building and up to 300 m outdoors, with direct line of sight between the mobile reader 1 and the base station. The identification information is converted by the operational-information computer 13 from the data transmission standard used for the communication between the base stations 14, 15, 16, 17 and the mobile reader 1 into the data standard for the central computer 12 used internally at operational level. The same applies for the information issued by the central computer 12 in response to incoming identification information relating to completed and future processing stages of the relevant object 9, which is sent to the operational-information computer 13, converted by the latter and transmitted via the corresponding base station to the mobile reader 1, where it is displayed for the operator on the display device 4.

Additionally, a stationary holder and charging station (not illustrated), into which the relevant mobile reader 1 can be plugged and charged while it is not being used, may be provided for every mobile reader 1. In this context, the stationary holders and charging stations, can be coupled either in a wireless manner or via hard-wiring to the network 11, so that an operator can only use a mobile reader 1 after entering a personal password. In this context, the release of the mobile readers 1 can be controlled by the central computer, for example, via the corresponding holders and charging stations.

1. Mobile reader (1) for reading out information from a transponder (10), with
a first transmitter/receiver device (2) for transmitting a read-out signal to a transponder (10) and for receiving a response signal with identification information for the identification of the transponder (10) emitted by a transponder (10) in response to the read-out signal, wherein the first transmitter/receiver device (2) operates in a wireless manner and on the basis of electromagnetic waves within a first frequency range; and
a second transmitter/receiver device (3) for wireless communication with a base station (14; 15; 16; 17) on the basis of electromagnetic waves in a second frequency range, wherein the second transmitter/receiver device (3) communicates the identification information received in the response signal from the first transmitter/receiver device to the base station (14; 15; 16; 17).

2. Mobile reader (1) according to claim 1,
characterised by
a micro-controller (6) for converting the identification information contained in the response signal into a signal format to be transmitted by the second transmitter/receiver device (3) to the base station (14; 15; 16; 17).

3. Mobile reader (1) according to claim 1 or 2,
characterised in that,
in response to transmitted identification information, the second transmitter/receiver device (3) receives from the base station (14; 15; 16; 17) transmitted processing information referring to the processing of the transponder (10).

4. Mobile reader (1) according to claim 3,
characterised by
a display device (4) for displaying the processing information received from the base station (14; 15; 16; 17).

5. Mobile reader (1) according to any one of claims 1 to 4,
characterized in that
the communication between the first transmitter/receiver device (2) and the transponder (10) takes place on the basis of amplitude-modulated signals.

6. Mobile reader (1) according to any one of claims 1 to 4,
characterized in that
the communication between the first transmitter/receiver device (2) and the transponder (10) takes place on the basis of frequency-modulated signals.

7. Mobile reader (1) according to any one of claims 1 to 6,
characterised in that
the first frequency range is disposed within the range of some hundred kHz.

8. Mobile reader (1) according to any one of claims 1 to 6,
characterised in that
the first frequency range is disposed within the range of some MHz.

9. Mobile reader (1) according to any one of claims 1 to 8,
characterised in that
the second transmitter/receiver device (3) communicates with the base station (14; 15; 16; 17) on the basis of the DECT standard.

10. Mobile reader (1) according to any one of claims 1 to 9,
characterised in that
the second frequency range is disposed within the range of some GHz.

11. Network (11) for monitoring objects (9) carrying transponders (10), with several base stations (14; 15; 16; 17) for communicating with mobile readers. (1) according to any one of the preceding claims; and
a central computer (12) for storing and managing information relating to the processing of the objects (9) carrying the transponders (10), wherein, on receiving identification information from a base station (14; 50; 16; 70), the central computer (12) sends processing information referring to the relevant transponder back to the base station.

12. Network according to claim 11,
characterised in that
the central computer (12) is connected to processing stations (18) for processing the objects (9) carrying transponders (10), wherein each processing station (18) comprises a processing device (19) for registering the processing status of an object (9) carrying a transponder (10) in the processing station (18) and for communicating the corresponding processing information to the central computer (12).

13. Network (11) according to claim 11 or 12,
characterised in that
an operational-information computer (13) is provided for controlling the communication between the central computer (12 and the base stations (14; 15; 16; 17).
